(19) United States
(12) Patent Application Publication
(10) Pub. No.: US 2016/0105125 A1
(43) Pub. Date: Apr. 14, 2016

(54) POWER SUPPLY APPARATUS

(71) Applicant: Samsung Electro-Mechanics Co., Ltd., Suwon-si (KR)

(72) Inventor: Won Young LEE, Suwon-si (KR)

(73) Assignee: Samsung Electro-Mechanics Co., Ltd., Suwon-si (KR)

(21) Appl. No.: 14/670,282

(22) Filed: Mar. 26, 2015

(30) Foreign Application Priority Data
Oct. 14, 2014 (KR) 10-2014-0138591

(51) Int. Cl. H02M 7/06

(52) U.S. Cl. CPC H02M 7/06

(57) ABSTRACT

A power supply apparatus may include a conversion unit converting an input voltage, an output unit stabilizing a voltage output by the conversion unit and outputting the voltage, and an overcurrent detecting unit detecting the occurrence of an overcurrent state by sensing a ripple current flowing in the output unit.

### CROSS-REFERENCE TO RELATED APPLICATION

This application claims the priority and benefit of Korean Patent Application No. 10-2014-0138591 filed on Oct. 14, 2014, with the Korean Intellectual Property Office, the disclosure of which is incorporated herein by reference.

### BACKGROUND

The present disclosure relates to a power supply apparatus.

In the field of power supply apparatuses, overcurrent detection is an important issue.

An example of a general overcurrent detection scheme includes a scheme in which an overcurrent is detected using a current flowing on the primary side of a transformer. However, according to the above-mentioned scheme, when a transformer has a plurality of secondary sides, a high overcurrent reference value may be set, and when some of the plurality of secondary sides are not operated, an overcurrent may not be detected.

Another example of an overcurrent detection scheme includes a scheme of detecting an overcurrent using a current flowing on the secondary side of a transformer. According to the above-mentioned scheme, the overcurrent is detected by sensing an output current as it is. Therefore, the output current of the power supply apparatus has a relatively high value and consequently, in order to sense an output current, a resistor having high wattage should be used, which may result in an increase in an overall size of an apparatus due to the size of the resistor.

In addition, since a level of the output current may be high, a separate integrated circuit for leveling the detected output current down to a predetermined level is also required.

The related art associated with the above inventions may be understood with reference to Korean Patent Laid-Open Publication No. 1998-086004.

### Related Art Document

(Patent Document 1) Korean Patent Laid-Open Publication No. 1998-086004

### SUMMARY

An aspect of the present disclosure may provide a power supply apparatus capable of detecting an overcurrent while having a simple configuration.

According to an aspect of the present disclosure, a power supply apparatus may include a conversion unit converting an input voltage, an output unit stabilizing a voltage output by the conversion unit and outputting the voltage, and an overcurrent detecting unit detecting an overcurrent state by sensing a ripple current flowing in the output unit.

According to another aspect of the present disclosure, a power supply apparatus may include a conversion unit converting an input voltage, a first output unit and a second output unit stabilizing a voltage output by the conversion unit and outputting the voltage, and an overcurrent detecting unit detecting an overcurrent state in the respective first and second output units by sensing ripple currents flowing in the first output unit and the second output unit, respectively.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a configuration diagram describing a power supply apparatus according to an exemplary embodiment of the present disclosure;

FIG. 2 is a circuit diagram illustrating an example of a conversion unit and an output unit of FIG. 1;

FIG. 3 is a circuit diagram illustrating an example of an overcurrent detecting unit of FIG. 2;

FIG. 4 is a circuit diagram illustrating another example of the conversion unit and the output unit of FIG. 1;

FIG. 5 is a circuit diagram illustrating an example of an overcurrent detecting unit of FIG. 4;

FIGS. 6A through 6D are graphs illustrating a current and a ripple voltage; and

FIG. 7 is a graph illustrating a relationship between the current and the ripple voltage.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements May be exaggerated for clarity, and the same reference numerals will be used throughout to designate the same or like elements.

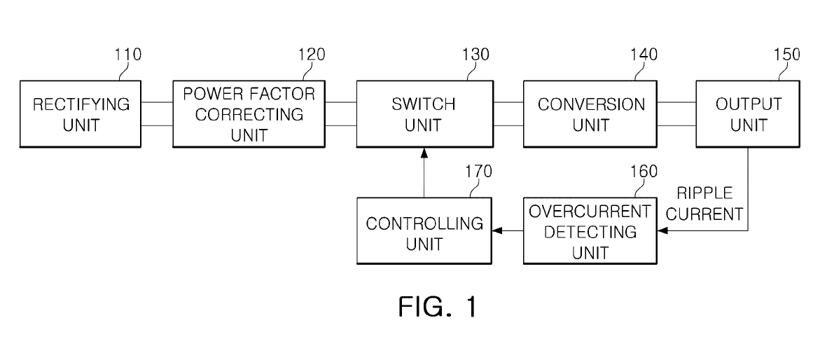

FIG. 1 is a configuration diagram describing a power supply apparatus according to an exemplary embodiment of the present disclosure.

Referring to FIG. 1, a power supply apparatus 100 according to an exemplary embodiment of the present disclosure may include a conversion unit 140, an output unit 150, and an overcurrent detecting unit 160. According to an exemplary embodiment of the present disclosure, the power supply apparatus 100 may further include at least one of the rectifying unit 110, a power factor correcting unit 120, a switch unit 130, and a controlling unit 170.

The rectifying unit 110 may rectify alternating current power that is input to an input terminal (in) and transfer the rectified alternating current power to the power factor correcting unit 120. According to an exemplary embodiment of the present disclosure, the rectifying unit 110 may further perform a smoothing function.

The power factor correcting unit 120 may correct a power factor by adjusting a phase difference between a voltage and a current of the power transferred from the rectifying unit 110.

The switch unit 130 may include a switch connected between a node to which direct current power from the power factor correcting unit 120 is input and a ground. As an example, the switch unit 130 may include two switches that are connected in series with each other and may perform a power converting operation by alternate switching operations of the two switches.

The switch unit 130 may perform the switching operation in response to a control signal of the controlling unit 170.

The conversion unit 140 may convert an input voltage input thereto.

According to an exemplary embodiment of the present disclosure, the conversion unit 140 may include a resonance tank and a transformer. The resonance tank may be configured by an inductor-inductor-capacitor (LLC) circuit or an inductor-capacitor (LC) circuit, so as to perform a resonance operation.

The transformer may include a primary winding and a secondary winding, wherein the primary winding and the secondary winding may be electrically insulated from each other. That is, the primary winding and the secondary winding may have different electrical properties of a ground. The primary winding and the secondary winding may form a preset turns ratio, wherein the secondary winding may vary a voltage level depending on the turns ratio and output power having the varied voltage level.

In addition, the rectifying unit 110, the power factor correcting unit 120, the switch unit 130, the resonance tank, and the primary winding of the transformer may be formed at the primary side, and the secondary winding of the transformer and the output unit 150 may be formed at the secondary side.

The output unit 150 may stabilize the power from the secondary winding of the conversion unit 140 and output the stabilized power to an output terminal. The output unit 150 may further perform a rectifying function according to an exemplary embodiment of the present disclosure.

According to an exemplary embodiment of the present disclosure, the output unit 150 may include a plurality of capacitors connected to each other in parallel. According to the present exemplary embodiment of the present disclosure, the plurality of capacitors connected to each other in parallel only need to have a connection relationship, a parallel connection relationship, regardless of functions of the respective capacitors. That is, a capacitor configuring a filter and an output capacitor may configure the parallel connection relationship. Alternatively, a capacitor of the rectifying circuit, the capacitor configuring the filter and the output capacitor may configure the parallel connection relationship.

The overcurrent detecting unit 160 may detect whether or not an overcurrent has occurred by sensing a ripple current flowing in the output unit 150.

According to an exemplary embodiment of the present disclosure, the overcurrent detecting unit 160 may detect whether or not an overcurrent has occurred by sensing a ripple current flowing in at least one of the plurality of capacitors included in the output unit 150. For example, the overcurrent detecting unit 160 may detect the occurrence of an overcurrent state by sensing the ripple current generated at the time of charging and discharging any one of the capacitors connected to each other in parallel.

According to the above-mentioned exemplary embodiment of the present disclosure, since the ripple current has characteristics that it is proportional to the output current, a fact that magnitude of the ripple current at the time of occurrence of the overcurrent is also increased is used. In addition, in the case of the above-mentioned exemplary embodiment of the present disclosure, since the ripple current has a smaller value than the output current, a size of a resistance element for detecting the ripple current may be reduced.

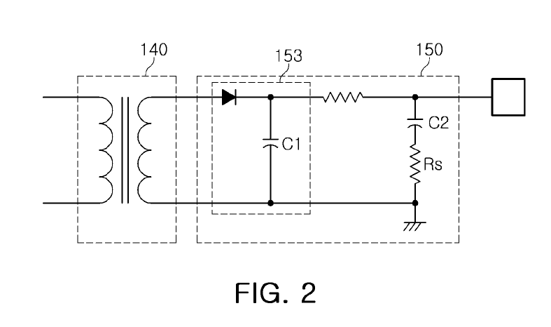

Various exemplary embodiments of the output unit 150 and the overcurrent detecting unit 160 will be described below in more detail with reference to FIGS. 2 through 5.

The controlling unit 170 may control an operation of the power supply apparatus 100.

If the controlling unit 170 receives an overcurrent detection signal from the overcurrent detecting unit 160, it may perform an overcurrent protection operation. For example, the controlling unit 170 may perform the overcurrent protection operation, that is, the controlling unit 170 may stop an operation of the power supply apparatus 100, discharge the overcurrent to the ground, and so forth.

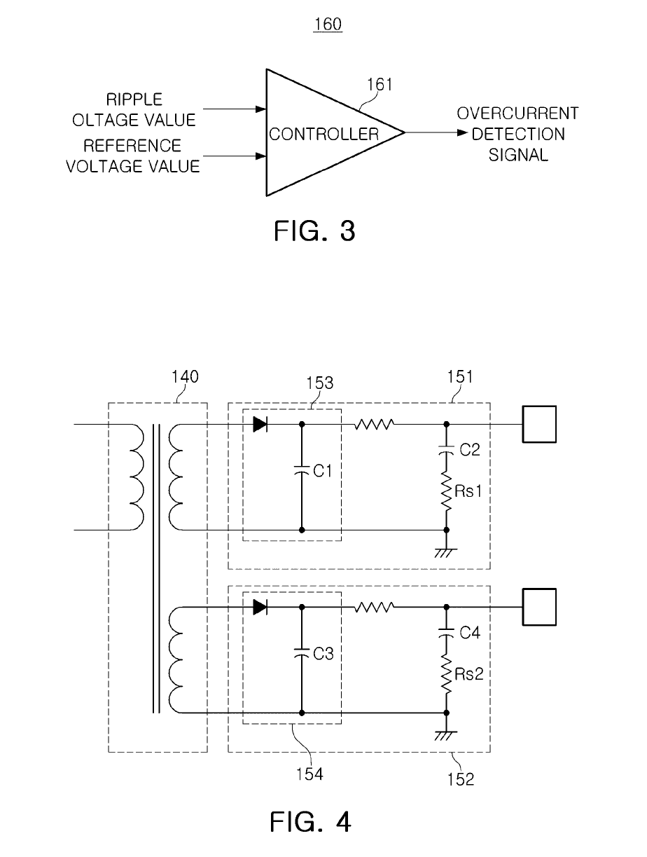

FIG. 2 is a circuit diagram illustrating an example of a conversion unit and an output unit of FIG. 1 and FIG. 3 is a circuit diagram illustrating an example of an overcurrent detecting unit of FIG. 2.

FIGS. 2 and 3 illustrate the examples related to the output unit having a single outputting circuit.

FIG. 2 illustrates an example of the conversion unit 140 and the output unit 150.

The output unit 150 may be connected to the secondary side of the conversion unit 140 and may include a filter circuit 153 and an output capacitor C2.

The filter circuit 153 may include a diode connected in series with a secondary coil of the conversion unit 140, and a filter capacitor C1 connected to the secondary coil in parallel.

The output capacitor C2 may be connected to the filter capacitor in parallel C1.

A sensing resistor Rs may be connected to at least one of a plurality of parallel capacitors included in the output unit 150, so as to detect the ripple current of the corresponding capacitor.

According to the example illustrated in FIG. 2, the sensing resistor Rs is connected to the output capacitor C2 in series, but it is merely illustrative. Depending on an exemplary embodiment of the present disclosure, the sensing resistor Rs may be connected to other capacitors connected to each other in parallel.

The overcurrent detecting unit 160 may determine whether or not the overcurrent is detected by using the ripple current detected by the sensing resistor Rs.

According to an exemplary embodiment of the present disclosure, the overcurrent detecting unit 160 may output the overcurrent detection signal in the case in which a ripple voltage corresponding to the ripple current of the output capacitor C2 detected by the sensing resistor Rs has a reference value or more.

FIG. 3 illustrates an example of the above-mentioned overcurrent detecting unit 160. Referring to FIG. 3, the overcurrent detecting unit 160 may include a comparator 161.

The comparator 161 may receive a ripple voltage value and compare the ripple voltage value with a reference voltage value, so as to output the overcurrent detection signal. Here, the ripple voltage value may be a value corresponding to the ripple current detected by the sensing resistor.

According to the present exemplary embodiment of the present disclosure, the overcurrent may be detected by using a simple comparator as illustrated. The reason is that since the sensing resistor Rs detecting the overcurrent is connected in series between the capacitor and a ground terminal, the ripple current detected by the sensing resistor Rs is measured based on the ground. Therefore, a separate calculation may not be required to calculate the ripple voltage value and the overcurrent may be detected by a simple comparison.

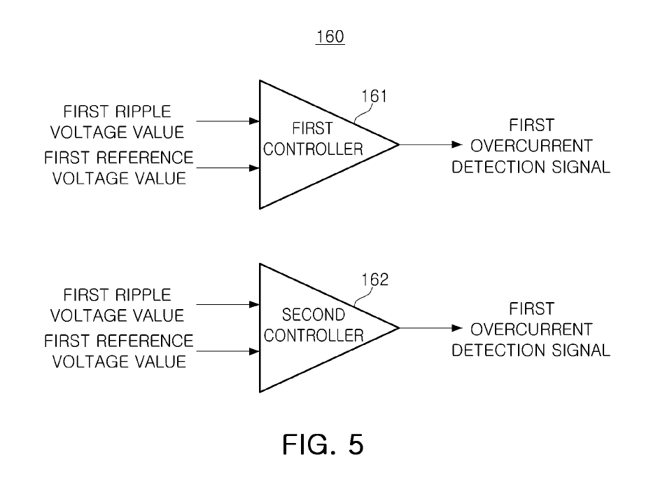

FIG. 4 is a circuit diagram illustrating another example of the conversion unit and the output unit of FIG. 1 and FIG. 5 is a circuit diagram illustrating an example of an overcurrent detecting unit of FIG. 4.

FIGS. 4 and 5 illustrate the examples related to the output unit having two outputting circuits. Hereinafter, an example having the two outputting circuits will be described, but a case having two outputting circuits or more may also be understood according to the following description.

Referring to FIG. 4, a first output unit 151 and a second output unit 152 may be respectively connected to the conversion unit 140. Secondary windings of the conversion unit 140 to which the first output unit 151 and the second output unit 152 are connected may each have different turns ratio.

The first output unit 151 and the second output unit 152 may each include a plurality of capacitors connected to each other in parallel.

According to an illustrated example, the first and second output units 151 and 152 may each include filter circuits 153 and 154, and output capacitors C2 and C4.

The filter circuits 153 and 154 may include a diode connected in series with a secondary coil of the conversion unit 140, and filter capacitors C1 and C3 connected to the secondary coil in parallel. The output capacitors C2 and C4 may be each connected to the filter capacitor in parallels C1 and C3.

Sensing resistors Rs1 and Rs2 may be connected to at least one of a plurality of parallel capacitors included in the first and second output units 151 and 152, so as to detect the ripple current of the corresponding capacitor. According to the example illustrated in FIG. 4, the sensing resistors Rs1 and Rs2 are each connected to the output capacitors C2 and C4 in series, but it is merely illustrative. Depending on an exemplary embodiment of the present disclosure, the sensing resistors Rs1 and Rs2 may be each connected to other capacitors connected to each other in parallel.

The overcurrent detecting unit 160 may determine whether or not the overcurrent is detected by using the ripple currents detected by the sensing resistors Rs1 and Rs2.

The overcurrent detecting unit 160 may separately determine whether or not an overcurrent has occurred in the respective first and second output units 151 and 152. For example, the overcurrent detecting unit 160 may detect the occurrence of an overcurrent state in the respective first and second output units 151 and 152 by sensing the ripple currents flowing in the first output unit 151 and the second output unit 152, respectively.

FIG. 5 illustrates an example of the above-mentioned overcurrent detecting unit 160. Referring to FIG. 5, the overcurrent detecting unit 160 may include a first comparator 161 and a second comparator 162.

The first comparator 161 may receive a first ripple voltage value corresponding to the ripple current detected by the first sensing resistor Rs1 and compare the first ripple voltage value with a first reference value. The second comparator 162 may receive a second ripple voltage value corresponding to the ripple current detected by the second sensing resistor Rs2 and compare the second ripple voltage value with a second reference value.

Therefore, the overcurrent detecting unit 160 may each determine whether or not an overcurrent has occurred by using a simple configuration even in the case of the plurality of output units 150. Therefore, according to the present disclosure, the overcurrent may be more accurately and separately managed.

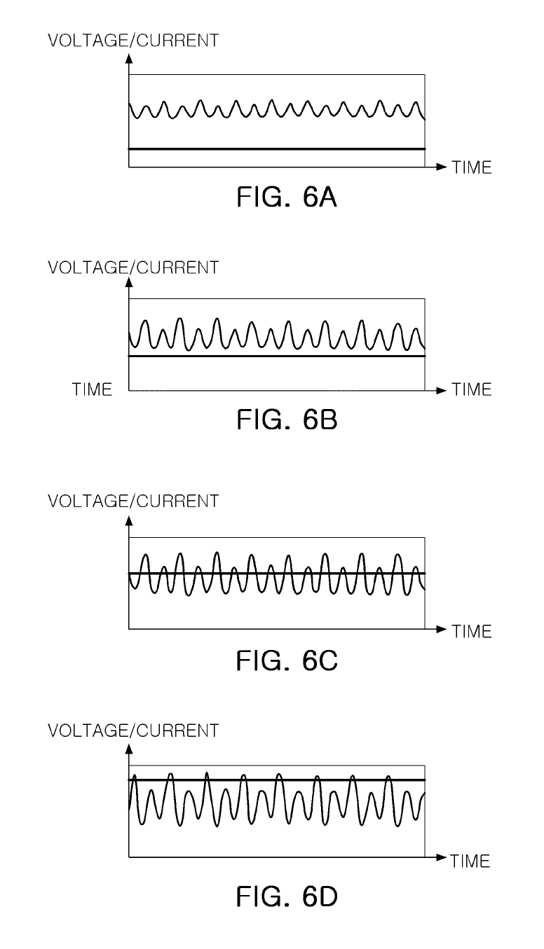

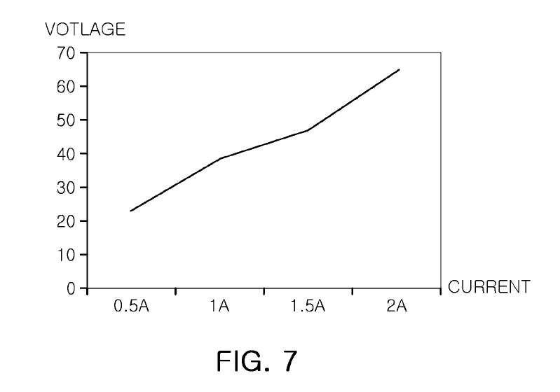

FIG. 6 is a graph illustrating a current and a ripple voltage and FIG. 7 is a graph illustrating a relationship between the current and the ripple voltage.

In FIG. 6, portions indicated by a bold straight line illustrate currents output from the output units (150 in FIG. 1, 150 in FIGS. 2, and 151 and 152 in FIG. 5) to a load (not illustrated), and solid lines illustrate the ripple voltages detected by the sensing resistors (Rs in FIG. 2, and Rs1 and Rs2 in FIG. 4). As illustrated in FIG. 6, it may be seen that as magnitude of the current (bold straight line) is increased, amplitude of the ripple voltage (solid line) is also increased. That is, when it is assumed that FIGS. 6A through 6C illustrate a normal state and FIG. 6D illustrates an overcurrent state, it may be appreciated from FIG. 6D that a maximum value of the ripple voltage in the overcurrent state is larger than that of FIGS. 6A through 6D.

Therefore, the overcurrent detecting unit 160 may detect the occurrence of an overcurrent state by setting a value corresponding to the maximum value of the ripple voltage corresponding to the overcurrent state to the reference voltage value.

A proportional relationship between the current and ripple voltage may also be confirmed from FIG. 7. In FIG. 7, the current illustrates the current output from the output unit (150 in FIG. 1, 150 in FIGS. 2, and 151 and 152 in FIG. 5) to a load (not illustrated), and the voltage illustrates a maximum value of the ripple voltage detected by the sensing resistors (Rs in FIG. 2, and Rs1 and Rs2 in FIG. 4). As illustrated in FIG. 7, it may be appreciated that magnitude of the ripple voltage is proportional to magnitude of the current.

As set forth above, according to exemplary embodiments of the present disclosure, feedback power may be obtained by the simple configuration.

It may be checked by the simple configuration whether or not the piezoelectric transformer is damaged.

While exemplary embodiments have been shown and described above, it will be apparent to those skilled in the art that modifications and variations could be made without departing from the scope of the present invention as defined by the appended claims.

What is claimed is:

1. A power supply apparatus comprising:
a conversion unit converting an input voltage to an output voltage;
an output unit stabilizing the output voltage from the conversion unit and outputting a stabilized voltage; and
an overcurrent detecting unit detecting an occurrence of an overcurrent state by sensing a ripple current flowing in the output unit.

2. The power supply apparatus of claim 1, wherein the output unit includes a plurality of capacitors connected to each other in parallel.

3. The power supply apparatus of claim 2, wherein the overcurrent detecting unit detects the occurrence of an overcurrent state by sensing a ripple current flowing in at least one of the plurality of capacitors.

4. The power supply apparatus of claim 1, wherein the output unit includes:
a filter circuit including a filter capacitor; and
an output capacitor connected to the filter capacitor in parallel.

5. The power supply apparatus of claim 4, wherein the overcurrent detecting unit includes a sensing resistor connected to the output capacitor in series.

6. The power supply apparatus of claim 5, wherein the overcurrent detecting unit outputs an overcurrent detection signal when a ripple voltage corresponding to a ripple current of the output capacitor detected by the sensing resistor has a level equal to or higher than a reference value.

7. The power supply apparatus of claim 5, wherein the overcurrent detecting unit further includes a comparator receiving a ripple voltage value corresponding to the ripple current detected by the sensing resistor and comparing the ripple voltage value with a reference value.

8. A power supply apparatus comprising:
a conversion unit converting an input voltage to an output voltage;
a first output unit and a second output unit stabilizing the output voltage from the conversion unit and outputting a stabilized voltage; and
an overcurrent detecting unit detecting an occurrence of an overcurrent state in the respective first and second output units by sensing ripple currents flowing in the first output unit and the second output unit, respectively.

9. The power supply apparatus of claim 8, wherein the first output unit and the second output unit respectively include a plurality of capacitors connected to each other in parallel.

10. The power supply apparatus of claim 9, wherein the overcurrent detecting unit detects the occurrence of an overcurrent state in the respective first and second output units by sensing a ripple current flowing in at least one of the plurality of capacitors.

11. The power supply apparatus of claim 8, wherein the first output unit includes:
a first filter circuit including a first filter capacitor; and
a first output capacitor connected to the first filter circuit in parallel, and
the second output unit includes:
a second filter circuit including a second filter capacitor; and
a second output capacitor connected to the second filter circuit in parallel.

12. The power supply apparatus of claim 11, wherein the overcurrent detecting unit includes:
a first sensing resistor connected to the first output capacitor in series; and
a second sensing resistor connected to the second output capacitor in series.

13. The power supply apparatus of claim 12, wherein the overcurrent detecting unit further includes:
a first comparator receiving a first ripple voltage value corresponding to the ripple current detected by the first sensing resistor and comparing the first ripple voltage value with a first reference value; and
a second comparator receiving a second ripple voltage value corresponding to the ripple current detected by the second sensing resistor and comparing the second ripple voltage value with a second reference value.
